(19) United States
(12) Patent Application Publication
(10) Pub. No.: US 2010/0165080 A1
(43) Pub. Date: Jul. 1, 2010

(54) IMAGE CAPTURING APPARATUS AND ENDOSCOPE

(75) Inventors: Hiroshi Yamaguchi, (US); Azuchi Endo, (US); Kiyohiro Maeda, (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM Corporation, Tokyo (JP)

(21) Appl. No.: 12/647,171

(22) Filed: Dec. 24, 2009

(30) Foreign Application Priority Data
Dec. 26, 2008 (JP) 2008-334948
Dec. 26, 2008 (JP) 2008-334960

(51) Int. Cl. H04N 13/00

(52) U.S. Cl. 348/45; 348/E13.001

(57) ABSTRACT

An image capturing apparatus includes a light splitting section that splits light from an object into first light and second light in such a manner that (i) a split ratio of light in a central region of an image of the object is different from a split ratio of light in a peripheral region of the image and (ii) the second light has a smaller amount of light in the central region than the first light, a first imaging element that receives the first light, a second imaging element that receives the second light, and a zoom lens system that is provided between the light splitting section and the first imaging element.

### CROSS REFERENCE TO RELATED APPLICATION

The present application claims priority from Japanese Patent Applications Nos. 2008-334948 filed on Dec. 26, 2008 and 2008-334960 filed on Dec. 26, 2008, the contents of which are incorporated herein by reference.

### BACKGROUND

1. Technical Field

The present invention relates to a double-sensor image capturing apparatus and to an endoscope used for examining the inside of an biological body.

2. Description of the Related Art

Japanese Patent Application Publication No. 2007-020866 discloses a technique of utilizing a Schmidt-Pechan prism to translate an optical axis by a predetermined distance, which can result in enlarging a portion of an image distant from the center of the image.

The technique disclosed in Japanese Patent Application Publication No. 2007-020866 can produce both normal images and enlarged images. The enlarged images, however, suffer from low brightness because a large number of optical systems are provided. Such a large number of optical systems, including the Schmidt-Pechan prism, increase the design complexity and cost. Moreover, since the light from an object is only partially used to capture the enlarged images, some of the light is not used and thus wasted. In addition, the endoscope disclosed in Japanese Patent Application Publication No. 2007-020866 can produce wide-angle images and enlarged images, but cannot have an image capturing element mounted at the end of the endoscope due to the large size of the optical systems. The endoscope inevitably has a large diameter at the end thereof.

### SUMMARY

Therefore, it is an object of an aspect of the innovations herein to provide an image capturing apparatus and an endoscope which are capable of overcoming the above drawbacks accompanying the related art. The above and other objects can be achieved by combinations described in the independent claims. The dependent claims define further advantageous and exemplary combinations of the innovations herein.

According to the first aspect related to the innovations herein, one exemplary image capturing apparatus may include a light splitting section that splits light from an object into first light and second light in such a manner that (i) a split ratio of light in a central region of an image of the object is different from a split ratio of light in a peripheral region of the image and (ii) the second light has a smaller amount of light in the central region than the first light, a first imaging element that receives the first light, a second imaging element that receives the second light, and a zoom lens system that is provided between the light splitting section and the first imaging element.

The light splitting section may split the light from the object into the first light and the second light such that the second light has a smaller amount of light in the central region than the first light and has a larger amount of light in the peripheral region than the first light.

The light splitting section may include a reflective mirror that has an opening positioned in correspondence with the central region.

The light splitting section may include a beam splitter that is positioned in correspondence with the central region, and a reflective mirror that is positioned in the same plane as the beam splitter in correspondence with the peripheral region.

The image capturing apparatus may further include a first light path adjusting section that causes the light from the object to form the image on the reflective mirror, a second light path adjusting section that is provided between the light splitting section and the first imaging element, where the second light path adjusting section causes the first light to be imaged on the first imaging element, and a third light path adjusting section that is provided between the light splitting section and the second imaging element, where the third light path adjusting section causes the second light to be imaged on the second imaging element.

The image capturing apparatus may further include an image generating section that generates an output image by combining together the image of the central region captured by the first imaging element and the image of the peripheral region captured by the second imaging element.

The image capturing apparatus is an endoscope apparatus including an endoscope, and the light splitting section, the first imaging element, the second imaging element, and the zoom lens system may be provided in an end of an insertion portion of the endoscope.

The light splitting section may supply the first light in a longitudinal direction of the endoscope and supply the second light in a direction substantially orthogonal to the longitudinal direction of the endoscope.

According to the second aspect related to the innovations herein, one exemplary endoscope may include an insertion portion, where the insertion portion includes, at an end thereof, a guiding section that guides light from an object into the endoscope, a light splitting section that reflects the guided light in a direction substantially orthogonal to a longitudinal direction of the endoscope and transmits the guided light in the longitudinal direction of the endoscope, where the light splitting section transmits a larger amount of the guided light than reflects, a first imaging element that receives the light reflected by the light splitting section, a second imaging element that receives the light transmitted by the light splitting section, and a zoom lens system that is provided between the light splitting section and the second imaging element.

According to the third aspect related to the innovations herein, one exemplary endoscope may include an insertion portion, where the insertion portion includes, at an end thereof, a guiding section that guides light from an object into the endoscope, a light splitting section that splits the guided light into two sets of light rays, a first imaging element that receives one of the two sets of light rays produced by the light splitting section, and a second imaging element that receives the other of the two sets of light rays produced by the light splitting section. Here, the second imaging element has a smaller area of effective pixels and a higher resolution per unit area than the first imaging element.

The light splitting section may split the guided light into the two sets of light rays having different amounts of light, the first imaging element may receive one of the two sets of light rays that has a smaller amount of light, and the second imaging element may receive one of the two sets of light rays that has a larger amount of light.

An image created by light received by the second imaging element may correspond to part of an image crated by light received by the first imaging element.

The summary clause does not necessarily describe all necessary features of the embodiments of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 illustrates an image capturing apparatus 100 relating to an embodiment of the present invention.

FIG. 2 illustrates an example of an image capturing section 112 provided within an end portion 121 of an endoscope 101.

FIG. 3 illustrates an example of a light splitting section 141.

FIG. 4 illustrates another example of the light splitting section 141.

FIG. 5 illustrates an exemplary image displayed on a display section 105 when the image capturing apparatus 100 is in a normal observation mode and a detailed observation mode.

FIG. 6 illustrates an exemplary image displayed on the display section 105 when the image capturing apparatus 100 is in the enlarged observation mode.

FIG. 7 illustrates an exemplary image displayed on the display section 105 when the image capturing apparatus 100 is in the enlarged observation mode.

FIG. 8 illustrates an endoscope system 1100 relating to an embodiment of the present invention.

FIG. 9 illustrates an example of an image capturing section 1112 provided within an end portion 1121 of an endoscope 1101.

FIG. 10 illustrates another example of the image capturing section 1112 provided within the end portion 1121 of the endoscope 1101.

FIG. 11 illustrates an example of a first image displayed.

FIG. 12 illustrates an example of a second image displayed.

FIG. 13 illustrates an exemplary concurrent display of the first and second images.

### DESCRIPTION OF EXEMPLARY EMBODIMENTS

Some aspects of the invention will now be described based on the embodiments, which do not intend to limit the scope of the present invention, but exemplify the invention. All of the features and the combinations thereof described in the embodiment are not necessarily essential to the invention.

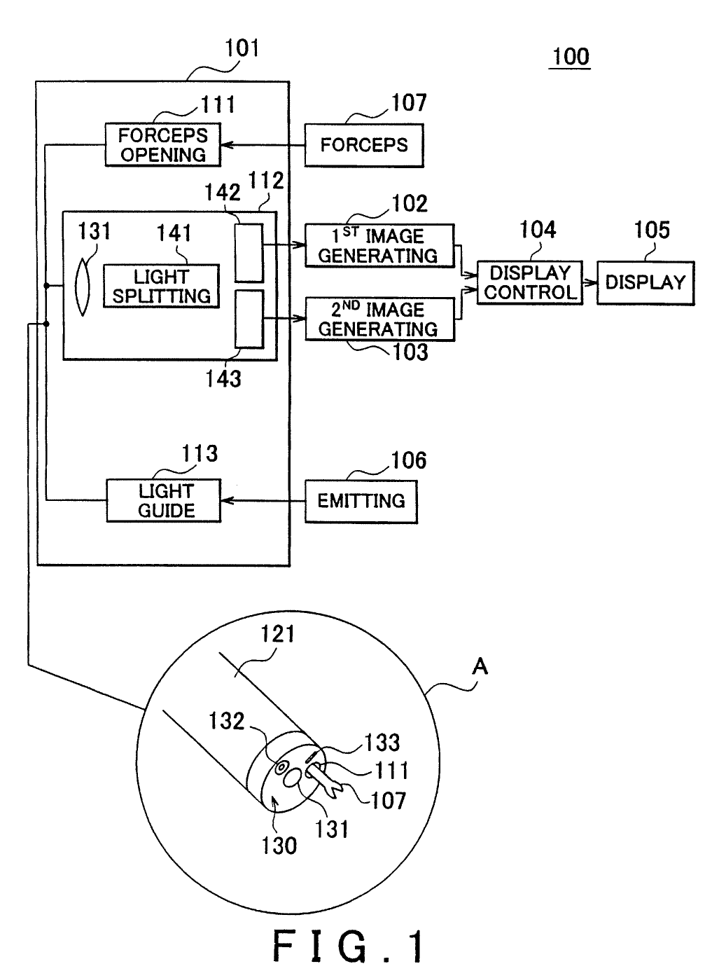

FIG. 1 illustrates an image capturing apparatus 100 relating to an embodiment of the present invention. The present embodiment will be described assuming a case where the image capturing apparatus 100 is applied, for example, to an endoscope system. The image capturing apparatus 100 includes an endoscope 101, a first image generating section 102, a second image generating section 103, a display control section 104, a display section 105, an emitting section 106, and a forceps 107. The portion designated by a reference sign of “A” in FIG. 1 is an enlarged view of an end portion 121 of the endoscope 101.

The endoscope 101 includes a forceps opening 111, an image capturing section 112, and a light guide 113. The end portion 121 of the endoscope 101 has, on an end surface 130 thereof, a lens 131 that is part of the image capturing section 112. The end portion 121 also has, on the end surface 130 thereof, an exit 132 that is part of the light guide 113.

The emitting section 106 emits light towards an object. The emitting section 106 may emit white light to the object. The emitting section 106 may emit excited light. The emitting section 106 may emit white light and excited light. The emitting section 106 may emit light having a specified range of wavelengths. The emitting section 106 may emit light with a particular state of polarization. The light guide 113 is formed, for example, by an optical fiber. The light guide 113 guides the light emitted from the emitting section 106 to the end portion 121 of the endoscope 101. The light emitted from the emitting section 106 passes through the light guide 113 and is emitted from the exit 132 at the end surface 130, to be applied to the object. When the emitting section 106 is configured to emit light having a specified state of polarization, the light guide 113 maintains the polarization state of the light while guiding the light having the specified state of polarization emitted from the emitting section 106 to the end portion 121.

The image capturing section 112 may be positioned within the end portion 121 of the endoscope 101. The image capturing section 112 at least includes a lens 131, a light splitting section 141, a first imaging element 142, and a second imaging element 143. The light splitting section 141 splits the light from the object into first light and second light. Here, the light splitting section 141 splits the light from the object into first light and second light in such a manner that (i) the split ratio of light in the central region of the image of the object is different from the split ratio of light in the peripheral region of the image and (ii) the second light has a smaller amount of light in the central region than the first light. Here, the light splitting section 141 may split the light from the object into the first light and the second light such that the second light has a smaller amount of light in the central region than the first light and has a larger amount of light in the peripheral region than the first light. The first imaging element 142 receives the first light from the light splitting section 141. The second imaging element 143 receives the second light from the light splitting section 141. Here, the first and second imaging elements 142 and 143 may be the same in terms of function, capability and size.

The image capturing section 112 may include an imaging element driver that drives the first and second imaging elements 142 and 143, an AD converter, and some other constituents. The imaging element driver reads the amount of the light received by the first imaging element 142 and the amount of the light received by the second imaging element 143. The AD converter converts, into digital signals, the image information read from the first imaging element 142 and the image information read from the second imaging element 143. The imaging element driver, AD converter and the other constituents are controlled by an information processing apparatus such as a CPU. The information processing apparatus may be provided within the image capturing section 112 or within the image capturing apparatus 100.

The first image generating section 102 performs image processing on the image captured by the first imaging element 142 to generate a first image. When the first imaging element 142 includes, for example, RGB color filters, the first image generating section 102 may generate an image represented by a luma-chroma signal. The first image generating section 102 sends the generated first image to the display control section 104. The second image generating section 103 performs image processing on the image captured by the second imaging element 143 to generate a second image. When the second imaging element 143 includes, for example, RGB color filters, the second image generating section 103 may generate an image represented by a luma-chroma signal. The second image generating section 103 sends the generated second image to the display control section 104.

The display control section 104 causes the display section 105 to display the first image. The display control section 104 causes the display section 105 to display the second image. The display control section 104 may cause the display section 105 to display an image resulting from combining together the first and second images. Here, the image capturing apparatus 100 may offer a normal observation mode, a detailed observation mode, and an enlarged observation mode. The display control section 104 may cause the display section 105 to display the image resulting from combining together the first and second images when the image capturing apparatus 100 is in the normal and detailed observation modes. The display control section 104 may cause the display section 105 to display the first image when the image capturing apparatus 100 is in the enlarged observation mode. The display control section 104 may be implemented by an information processing apparatus such as a CPU. The display section 105 is designed to display images. The display section 105 may be a liquid crystal display, an organic EL display, a plasma display or the like.

The image capturing apparatus 100 may include a storing section that stores images. The storing section may store the first image. The storing section may store the second image. The storing section may store an image resulting from combining together the first and second images that are simultaneously captured. The storing section may include a storage medium such as a flash memory and a storage control section that stores images onto the storage medium. The storage control section may be implemented by an information processing apparatus such as a CPU.

The forceps opening 111 receives a forceps 107, which is inserted thereto. The forceps opening 111 guides the forceps 107 to the end portion 121. The forceps 107 may have an end portion that comes in a variety of shapes. In addition to the forceps 107, the forceps opening 111 may receive a variety of tools to treat a biological body, which are inserted thereto. A nozzle 133 ejects water or air.

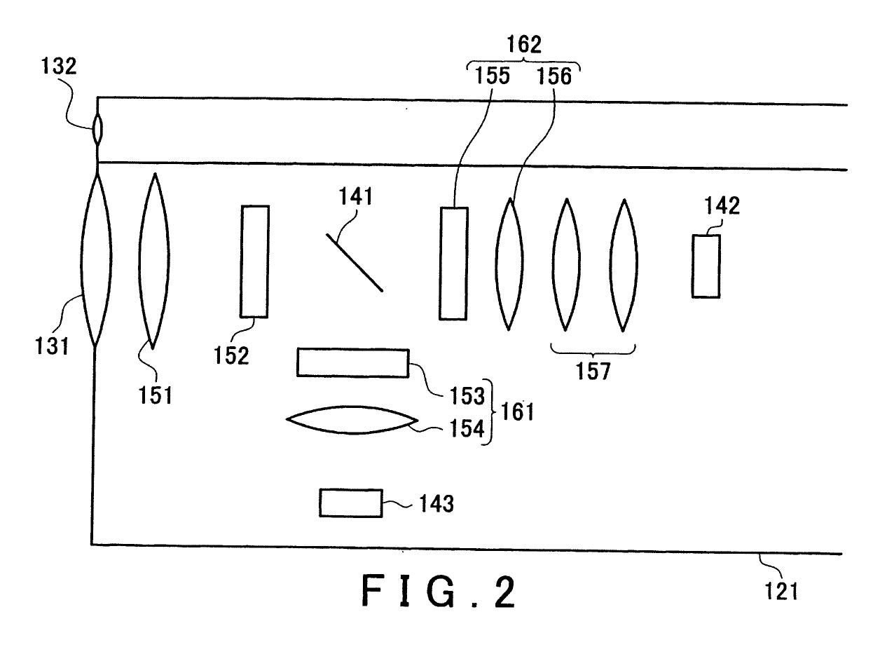

FIG. 2 illustrates an example of the image capturing section 112 provided within the end portion 121 of the endoscope 101. In addition to the lens 131, the light splitting section 141, the first imaging element 142, and the second imaging element 143, the image capturing section 112 includes a reduction optical system 151, a first light path adjusting section 152, a light path adjusting optical system 153, an imaging lens 154, a light path adjusting optical system 155, an imaging lens 156, and a zoom lens system 157. The end portion 121 has on the end surface 130 thereof the lens 131 and the exit 132. The optical axis of the lens 131 is substantially parallel to the longitudinal direction of the endoscope 101. The light from the object passes through the lens 131 and enters the reduction optical system 151. The reduction optical system 151 reduces the size of the image created by the incoming light. The reduction optical system 151 may reduce the size accordingly to the size of the light splitting section 141.

After passing through the reduction optical system 151, the light enters the first light path adjusting section 152. The first light path adjusting section 152 changes the light path length of each light ray such that the image of the object is formed on the light splitting section 141. In other words, the first light path adjusting section 152 adjusts the light path length of the light of each region such that the image of the object is formed on the light splitting section 141. The light splitting section 141 splits the incoming light into first light and second light by transmitting the light of the central region of the formed image and reflects at least the light of the peripheral region of the image. Here, the central region does not overlap the peripheral region. The light splitting section 141 transmits and directs the first light in the direction in which the optical axis of the lens 131 extends. The light splitting section 141 reflects and directs the second light in the direction substantially orthogonal to the direction in which the optical axis of the lens 131 extends.

The light path adjusting optical system 155 adjusts the light path length of the light of each subregion of the central region of the image of the object, which is transmitted by the light splitting section 141. The imaging lens 156 causes the light of the central region of the image of the object, which has passed through the light path adjusting optical system 155, to be imaged on the first imaging element 142. Thus, the light path adjusting optical system 155 adjusts the light path length of the light of each subregion of the central region of the image of the object such that the imaging lens 156 can cause the first light to be imaged on the first imaging element 142. Specifically speaking, the light path adjusting optical system 155 undoes the changes made by the first light path adjusting section 152 to the light path length of the light of each subregion. The light path adjusting optical system 155 and the imaging lens 156 together form a second light path adjusting section 162.

The zoom lens system 157 expands the light that has passed through the imaging lens 156, which enters the first imaging element 142. The first imaging element 142 can receive the central region of the image of the object, which has passed through the zoom lens system 157. The zoom lens system 157 may be initially positioned so as to be capable of enlarging the central region of the image. Here, the image capturing section 112 includes a driving section that drives the zoom lens system 157.

The light path adjusting optical system 153 adjusts the light path length of the light of the region of the image of the object, which is reflected by the light splitting section 141. The imaging lens 154 causes the light that has passed through the light path adjusting optical system 153 to be imaged on the second imaging element 143. In other words, the light path adjusting optical system 153 adjusts the light path length of the light of the region of the image of the object such that the imaging lens 154 can cause the second light to be imaged on the second imaging element 143. Specifically speaking, the light path adjusting optical system 153 undoes the changes made by the first light path adjusting section 152 to the light path length of the light of the region. The light path adjusting optical system 153 and the imaging lens 154 together form a third light path adjusting section 161. The second imaging element 143 receives the light that has passed through the imaging lens 154. As described above, the zoom lens system 157 is arranged in the longitudinal direction of the endoscope 101 in the present embodiment. Therefore, the end portion 121 of the endoscope 101 is not required to be increased in size in the present embodiment. In other words, an imaging element that is configured to capture an image based on the light that has passed through a relatively larger number of optical systems and the optical systems are arranged along the longitudinal direction of the endoscope 101 in the present embodiment. This eliminates the need of increasing the diameter, that is to say, the thickness of the endoscope 101.

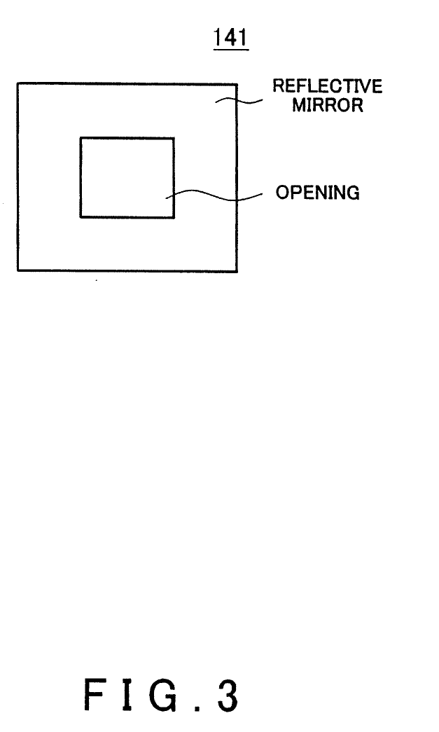

FIG. 3 illustrates an example of the light splitting section 141. The light splitting section 141 includes a reflective mirror. The reflective mirror has an opening in the center thereof. Through the opening, the light splitting section 141 transmits the light of the central region of the image of the object, which is formed on the reflective mirror by the first light path adjusting section 152. The light splitting section 141 also reflects the light of the peripheral region of the image of the object, which is formed on the reflective mirror by the first light path adjusting section 152. Here, the first light path adjusting section 152 causes the light to form the image of the object on the reflective mirror. With such a configuration, the first imaging element 142 can receive the light of the central region of the image of the object. The first imaging element 142 can also receive the expanded light of the central region of the image of the object, depending on the position of the zoom lens system 157. On the other hand, the second imaging element 143 can receive the light of the peripheral region of the image of the object. With the above-described configuration, what the light splitting section 141 transmits is limited to the light used by the first imaging element 142 to capture images. Therefore, no light is wasted. If the light splitting section 141 transmits any light components that will not be used by the first imaging element 142 to capture images, the amount of the light received by the second imaging element 143 is accordingly reduced. In this case, the second imaging element 143 can only capture dark images. The present embodiment can overcome such a problem. It is preferable that the zoom lens system 157 is initially positioned so as to be capable of expanding the first light to such a degree that the first imaging element 142 can receive the entire expanded first light.

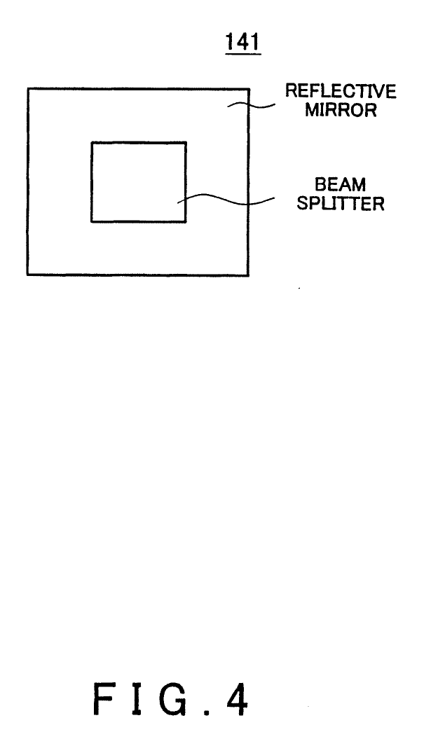

FIG. 4 illustrates another example of the light splitting section 141. The light splitting section 141 includes a beam splitter that is aligned with the central region and a reflective mirror that is aligned with the peripheral region and is in the same plane as the beam splitter. In other words, the light splitting section 141 shown in FIG. 4 has a beam splitter in place of the opening of the reflective mirror in FIG. 3 and the beam splitter it positioned in the same plane as the reflective mirror. The beam splitter transmits part of the received light and reflects the rest. The light reflected by the beam splitter has a lower intensity than the light transmitted by the beam splitter. Alternatively, the light reflected by the beam splitter may have substantially the same intensity as the light transmitted by the beam splitter. In other words, the beam splitter may be a semitransparent mirror.

The beam splitter of the light splitting section 141 transmits part of the light of the central region of the image of the object that is formed on the reflective mirror and beam splitter by the first light path adjusting section 152. The light transmitted by the light splitting section 141 in this way is referred to first light. The reflective mirror of the light splitting section 141 reflects the light of a region other than the central region of the image of the object that is formed on the reflective mirror and beam splitter. The beam splitter of the light splitting section 141 reflects part of the light of the central region of the image of the object that is formed on the reflective mirror and beam splitter. The light reflected by the light splitting section 141 in this way is referred to second light.

With the above-described configuration, the first imaging element 142 can receive the light of the central region of the image of the object. The first imaging element 142 can also receive the expanded light of the central region of the image of the object, depending on the position of the zoom lens system 157. It is preferable that the zoom lens system 157 is initially positioned so as to be capable of expanding the first light to such a degree that the first imaging element 142 can receive the entire expanded first light. On the other hand, the second imaging element 143 can receive the light of the entire image of the object. Thus, what the light splitting section 141 transmits is limited to the light used by the first imaging element 142 to capture images. Therefore, no light is wasted. If the light splitting section 141 transmits any light components that will not be used by the first imaging element 142 to capture images, the amount of the light received by the second imaging element 143 is accordingly reduced. In this case, the second imaging element 143 can only capture dark images. The present embodiment can overcome such a problem.

The following describes how the image capturing apparatus 100 operates. When the emitting section 106 emits light, the return light from the object under observation enters the lens 131 at the end surface 130 of the endoscope 101. The reduction optical system 151 reduces the size of the image of the object created by the light received by the lens 131. The first light path adjusting section 152 adjusts the light path length of the light that has passed through the reduction optical system 151, so that the image of the object is formed on the reflective mirror serving as the light splitting section 141. Here, when the light splitting section 141 is constituted by a reflective mirror and a beam splitter, forming an image on the reflective mirror includes forming an image on the reflective mirror and the beam splitter. The light splitting section 141 splits the received light into the first light corresponding to the light of the central region of the formed image of the object and the second light including the light of the peripheral region of the formed image of the object.

The second light path adjusting section 162 causes the first light to be imaged on the first imaging element 142. The first imaging element 142 receives the light that has passed through the zoom lens system 157. The third light path adjusting section 161 causes the second light to be imaged on the second imaging element 143. The second imaging element 143 receives the second light. The first image generating section 102 generates the first image from the image captured by the first imaging element 142 and outputs the first image to the display control section 104. The second image generating section 103 generates the second image from the image captured by the second imaging element 143 and outputs the second image to the display control section 104.

When the image capturing apparatus 100 is in the normal and detailed observation modes, the display control section 104 generates an image based on the first and second images. The display control section 104 then causes the display section 105 to display the generated image. When the light splitting section 141 is constituted by a reflective mirror having an opening in correspondence with the central region, the image captured by the second imaging element 143 has no image in the central region. Therefore, the display control section 104 combines together the first and second images and causes the display section 105 to display the resulting image. That is to say, the display control section 104 puts the first image into the central region of the second image to generate a complete image and causes the display section 105 to display the complete image. Here, note that the first image is an enlarged version of the central region of the image of the object. Therefore, the size of the first image is reduced to match the size of the central region missing in the second image, and the resulting first image is put into the central region of the second image. Here, the resolution of the first image is lowered when the image capturing apparatus 100 is in the normal observation mode. Specifically speaking, since the size-reduced first image has a higher resolution than the second image when the first and second imaging elements 142 and 143 have the same resolution and size, the resolution of the size-reduced first image is lowered. The resolution of the size-reduced first image may be lowered to the resolution of the second image. On the other hand, when the image capturing apparatus 100 is in the detailed observation mode, the display control section 104 combines together the first and second images without lowering the resolution of the size-reduced first image and causes the display section 105 to display the resulting image.

When the light splitting section 141 is configured such that a beam splitter is provided in correspondence with the central region and a reflective mirror is provided in correspondence with the peripheral region, the image captured by the second imaging element 143 is darker in the central region than an originally expected final image. Therefore, the display control section 104 combines together the first and second images and causes the display section 105 to display the resulting image. Specifically speaking, the display control section 104 adds the first image to the central region of the second image to generate a complete image and cause the display section 105 to display the complete image. Here, the first image is an enlarged version of the central region of the image of the object. Therefore, the size of the first image is reduced to match the size of the central region of the second image, and the resulting first image is combined with the second image. When the image capturing apparatus 100 is in the normal observation mode, the resolution of the size-reduced first image is lowered and the resulting first image is then combined with the second image. Here, the resolution of the size-reduced first image may be lowered to the resolution of the second image. When the image capturing apparatus 100 is in the detailed observation mode, the display control section 104 may combine together the first and second images without lowering the resolution of the size-reduced first image. The display control section 104 may cause the display section 105 to display a frame that indicates the boundary of the first image. In other words, the display control section 104 may cause the display section 105 to display a frame indicating the image of the central region captured by the first imaging element 142.

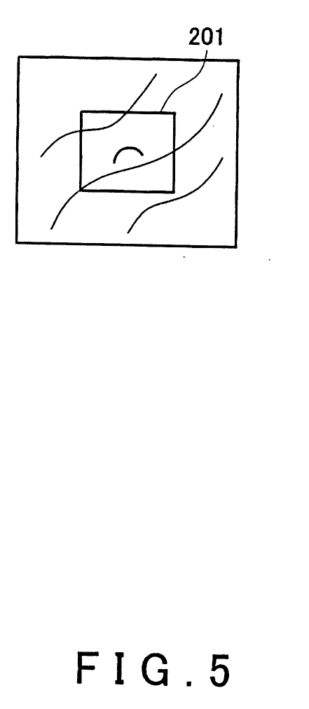

FIG. 5 illustrates an exemplary image displayed on the display section 105 when the image capturing apparatus 100 is in the normal observation mode and the detailed observation mode. As shown in FIG. 5, the display section 105 displays a frame 201 indicating the image of the central region captured by the first imaging element 142. In the example shown in FIG. 5, the display section 105 displays a combination result of the first and second images. By viewing the image displayed on the display section 105, a user can locate a diseased site. The user moves the end of the endoscope 101 in such a manner that a suspicious diseased site is placed within the frame 201.

When the image capturing apparatus 100 is in the normal observation mode, the first image whose size has been reduced and whose resolution has then been lowered is combined with the second image, and the resulting image is displayed. In other words, when the image capturing apparatus 100 is in the normal observation mode, the first image whose size has been reduced and whose resolution has then been lowered is displayed within the frame 201. When the user switches the operational mode of the image capturing apparatus 100 from the normal observation mode to the detailed observation mode by manipulation, the display control section 104 combines together the second image and the first image whose size has been reduced but whose resolution is not lowered and causes the display section 105 to display the resulting image. In this manner, the image is displayed with a higher resolution within the frame 201 than outside the frame 201. This enables the user to closely examine a suspicious diseased site by placing the suspicious diseased site within the frame 201.

When the image capturing apparatus 100 is in the enlarged observation mode, the display control section 104 causes the display section 105 to display the first image. In this manner, the image within the frame 201 can be displayed in the enlarged state. Since the frame 201 is displayed which indicates the boundary of the first image during the normal and detailed observation modes, the user can know which region is displayed in the enlarged state during the enlarged observation mode. When the image capturing apparatus 100 is in the enlarged observation mode, the display section 105 may display the complete image obtained by combining together the first and second images in a small window together with the first image.

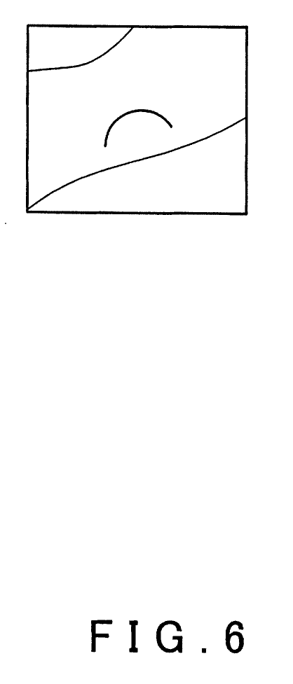

FIG. 6 illustrates an exemplary image displayed on the display section 105 when the image capturing apparatus is in the enlarged observation mode. During the enlarged observation mode, the display control section 104 causes the display section 105 to display full-screen the first image captured by the first imaging element 142. During the enlarged observation mode, the displayed first image may be further enlarged by moving the zoom lens system 157 while the first imaging element 142 is capturing an image of the object based on the first light. When the zoom lens system 157 is moved in the zoom direction, there may be a case where the first imaging element 142 can only receive part of the first light. Such a partial waste of the first light does not cause any problems since the complete image resulting from combining together the first and second images is not displayed on the display section. In other words, it is tolerable that part of the light from the object may be received by neither the first imaging element 142 nor the second imaging element 143.

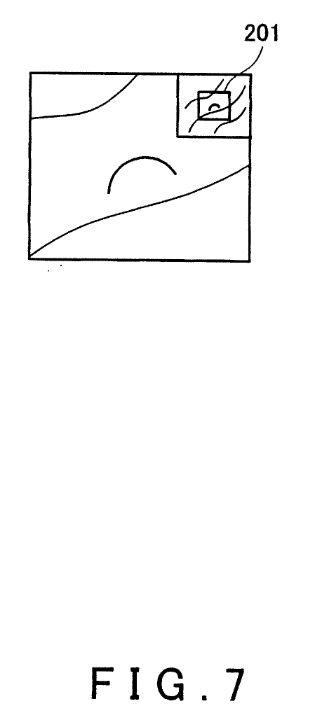

FIG. 7 illustrates an exemplary image displayed on the display section 105 when the image capturing apparatus 100 is in the enlarged observation mode. During the enlarged observation mode, the first image captured by the first imaging element 142 is displayed full-screen. In addition, the complete image obtained by combining together the first and second images may be displayed in a small window within the first image. If such is the case, the frame 201 may be displayed on the complete image to indicate which portion is enlarged. In this manner, the user can easily know which portion is currently enlarged. In this case, the zoom lens may be moved in the zoom direction. When the zoom lens is moved in the zoom direction, there may be case where the first imaging element 142 can only capture part of the first light. If such occurs, the first light is partially wasted. However, the complete image resulting from combining together the first and second images is allowed to be dark because of its small size. The complete image resulting from combining together the first and second images is allowed to be dark as long as it indicates which portion is enlarged.

As described above, the image capturing apparatus 100 includes the light splitting section 141 that splits light from an object into first light and second light in such a manner that (i) a split ratio of light in a central region of an image of the object is different from a split ratio of light in a peripheral region of the image and (ii) the second light has a smaller amount of light in the central region than the first light, the first imaging element 142 that receives the first light, the second imaging element 143 that receives the second light, and the zoom lens system 157 that is provided between the light splitting section 141 and the first imaging element 142. With such a configuration, the image capturing apparatus 100 can produce a zoomed image of the central region and a normal image including the peripheral region. The image capturing apparatus 100 can display a complete image by combining together the zoomed image of the central region and the normal image including the peripheral region, and additionally display the zoomed image of the central region. The image capturing apparatus 100 indicates the boundary of the zoomed image on the complete image, to enable the user to know which portion is zoomed. An information processing apparatus such as a CPU may function as the image capturing apparatus 100 by executing a predetermined program.

The above-described embodiment may be modified in the following manner.
(1) According to the above embodiment, the zoom lens system 157 is initially positioned so as to be capable of enlarging the central region of the image of the object. Alternatively, however, the zoom lens system 157 may be initially positioned so as not to enlarge the central region of the image of the object. Specifically speaking, the zoom lens system 157 may be positioned so as to zoom the central region of the image of the object at the magnification ratio of “1”. When the image capturing apparatus 100 is in the enlarged observation mode, the first image may be increasingly enlarged by moving the zoom lens.
(2) According to the above embodiment, the first image is displayed during the enlarged observation mode. Alternatively, however, when the zoom manipulation is performed during the enlarged observation mode, the complete image resulting from combining together the first and second images is gradually enlarged, so that the first image is displayed when the angle of view of the complete image resulting from combining the size-reduced first image with the second image becomes equal to the angle of view of the first image. After this, the zoom lens may be further moved in order to further enlarge the first image.
(3) The image capturing apparatus 100 may simultaneously display both the first image and the complete image obtained by combining together the first and second images. Specifically speaking, the image capturing apparatus 100 may define a first display region for displaying the complete image obtained by combining together the first and second images and a second display region for displaying the first image. In this case, the image capturing apparatus 100 may display the frame 201 indicating the boundary of the first image on the complete image obtained by combining together the first and second images. In other words, the image capturing apparatus 100 may simultaneously display the image shown in FIG. 5 and the image shown in FIG. 6.
(4) The light splitting section 141 may be alternatively configured to reflect the light of the central region of the image of the object and to transmit the light of the peripheral region. In this case, the reflected light is the first light, and the first imaging element 142 receives the first light. On the other hand, the transmitted light is the second light, and the second imaging element 143 receives the second light. The light splitting section 141 may alternatively be configured to partially reflect the light of the central region of the image of the object and transmit the rest of the light of the central region, and to transmit the light of the peripheral region. In this case, the reflected light is the first light, and the first imaging element 142 receives the first light. On the other hand, the transmitted light is the second light, and the second imaging element 143 receives the second light.
(5) The above-described modification examples (1) to (4) may be freely combined with each other.

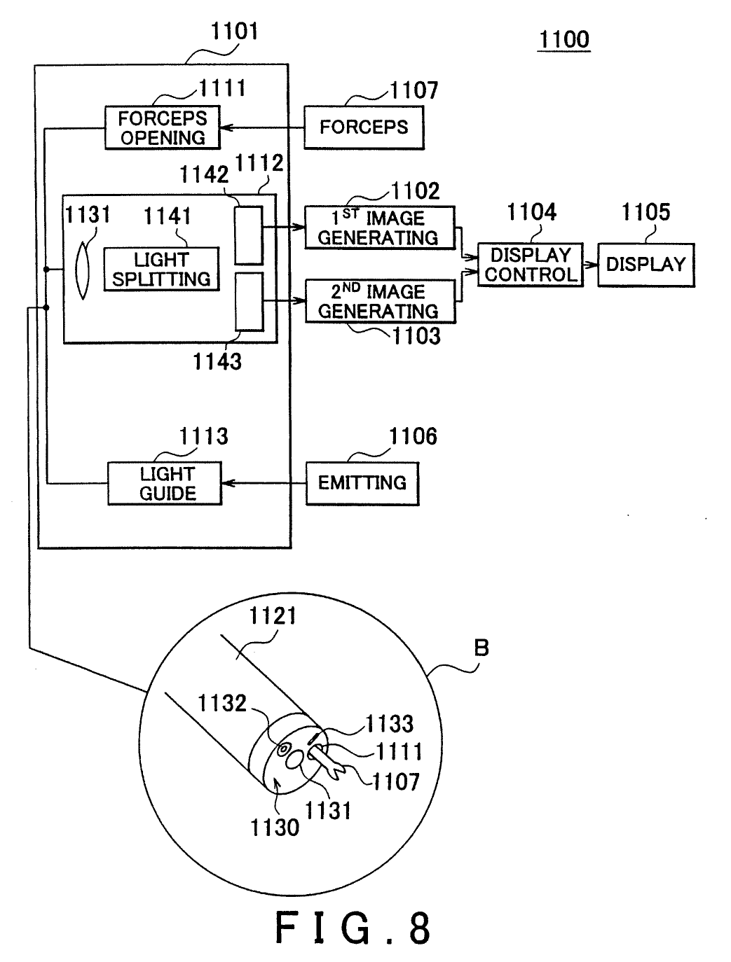

FIG. 8 illustrates an endoscope system 1100 relating to an embodiment of the present invention. The endoscope system 1100 includes an endoscope 1101, a first image generating section 1102, a second image generating section 1103, a display control section 1104, a display section 1105, an emitting section 1106, and a forceps 1107. The portion designated by a reference sign of “B” in FIG. 8 is an enlarged view of an end portion 1121 of an insertion portion of the endoscope 1101.

The endoscope 1101 includes a forceps opening 1111, an image capturing section 1112, and a light guide 1113. The end portion 1121 of the insertion portion of the endoscope 1101 has, on an end surface 1130 thereof, a guiding section 1131 that is part of the image capturing section 1112. The guiding section 1131 guides light from an object to the inside of the endoscope 1101. The guiding section 1131 may be a lens or an opening. The end portion 1121 also has, on the end surface 1130 thereof, an exit 1132 that is part of the light guide 1113. The forceps opening 1111 receives a forceps 1107, which is inserted thereto. The forceps opening 1111 guides the forceps 1107 to the end portion 1121. The forceps 1107 may have an end portion that comes in a variety of shapes. In addition to the forceps 1107, the forceps opening 1111 may receive a variety of tools to treat a biological body, which are inserted thereto. A nozzle 1133 ejects water or air.

The emitting section 1106 emits light towards an object. The emitting section 1106 may emit white light to the object. The emitting section 1106 may emit excited light. The emitting section 1106 may emit and switch between white light and excited light. The emitting section 1106 may emit light having a specified range of wavelengths. The emitting section 1106 may emit light with a particular state of polarization. The light guide 1113 is formed, for example, by an optical fiber. The light guide 1113 guides the light emitted from the emitting section 1106 to the end portion 1121 of the endoscope 1101. The light emitted from the emitting section 1106 passes through the light guide 1113 and is emitted from the exit 1132 at the end surface 1130, to be applied to the object. When the emitting section 1106 is configured to emit light having a specified state of polarization, the light guide 1113 maintains the polarization state of the light while guiding the light having the specified state of polarization emitted from the emitting section 1106 to the end portion 1121.

The image capturing section 1112 may be positioned within the end portion 1121 of the insertion portion of the endoscope 1101. The image capturing section 1112 at least includes the guiding section 1131, a light splitting section 1141, a first imaging element 1142 and a second imaging element 1143. The light splitting section 1141 splits the light guided inside by the guiding section 1131 into two sets of light rays. The light splitting section 1141 may split, into two sets of light rays that have different amounts of light, the light guided into the endoscope 1101 by the guiding section 1131. The first imaging element 1142 receives one of the sets of light rays produced by the light splitting section 1141. The second imaging element 1143 receives the other set of light rays produced by the light splitting section 1141. The image capturing section 1112 may include an imaging element driver that drives the first and second imaging elements 1142 and 1143, an AD converter, and some other constituents. The imaging element driver reads the image created by the light received by the first imaging element 1142 and the image created by the light received by the second imaging element 1143. The AD converter converts, into digital signals, the read image created by the light received by the first imaging element 1142 and the read image created by the light received by the second imaging element 1143. The imaging element driver, AD converter and the other constituents are controlled by an information processing apparatus such as a CPU. The information processing apparatus may be provided within the image capturing section 1112 or within the endoscope system 1100.

The first image generating section 1102 performs image processing on the image captured by the first imaging element 1142 to generate a first image. When the first imaging element 1142 includes, for example, RGB color filters, the first image generating section 1102 may generate an image represented by a luma-chroma signal. The first image generating section 1102 sends the generated first image to the display control section 1104. The second image generating section 1103 performs image processing on the image captured by the second imaging element 1143 to generate a second image. When the second imaging element 1143 includes, for example, RGB color filters, the second image generating section 1103 may generate an image represented by a luma-chroma signal. The second image generating section 1103 sends the generated second image to the display control section 1104.

The display control section 1104 causes the display section 1105 to display the first image. In addition, the display control section 1104 may cause the display section 1105 to display, on the first image, a frame indicating the boundary of the second image. In other words, the display control section 1104 may cause the display section 1105 to display a frame, on the first image, indicating the image capturing range of the second imaging element 1143. Also, the display control section 1104 causes the display section 1105 to display the second image. The display control section 1104 may cause the display section 1105 to display the image resulting from combining together the first and second images. Here, the endoscope system 1100 may offer a normal observation mode and an enlarged observation mode. The display control section 1104 may cause the display section 1105 to display the first image when the endoscope system 1100 is in the normal observation mode. The display control section 1104 may cause the display section 1105 to display the second image when the endoscope system 1100 is in the enlarged observation mode. The display control section 1104 may be implemented by an information processing apparatus such as a CPU. The display section 1105 is designed to display images. The display section 1105 may be a liquid crystal display, an organic EL display, a plasma display or the like.

The endoscope system 1100 may include a storing section that stores images. The storing section may store the first image. The storing section may store the second image. The storing section may store the image resulting from combining together the first and second images that are simultaneously captured. The storing section may include a storage medium such as a flash memory and a storage control section that stores images onto the storage medium. The storage control section may be implemented by an information processing apparatus such as a CPU.

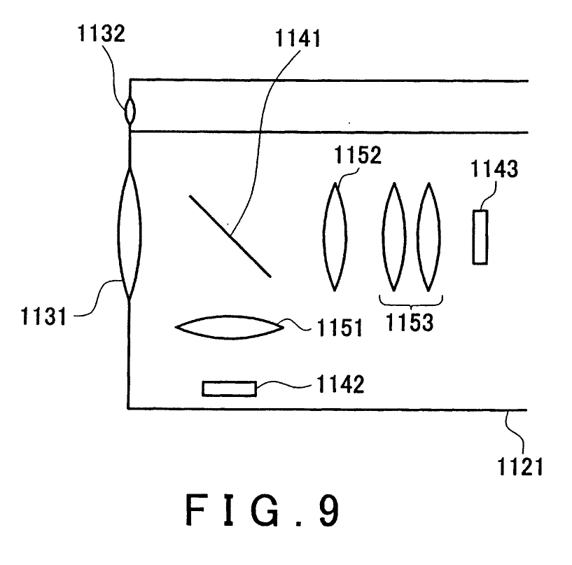

FIG. 9 illustrates an example of the image capturing section 1112 provided within the end portion 1121 of the endoscope 1101. In addition to the guiding section 1131, the light splitting section 1141, the first imaging element 1142, and the second imaging element 1143, the image capturing section 1112 includes an imaging lens 1151, an imaging lens 1152, and a zoom lens system 1153. The end portion 1121 has, at the end surface 1130 thereof, the guiding section 1131 and the exit 1132. The guiding section 1131 guides the light from the object into the endoscope 1101 substantially in the longitudinal direction of the endoscope 1101. When the guiding section 1131 is formed by a lens, the optical axis of the lens is substantially parallel to the longitudinal direction of the endoscope 1101. The light splitting section 1141 splits, into two sets of light rays, the light guided into the endoscope 1101 by the guiding section 1131, by transmitting part of the light and reflecting the rest. The light splitting section 1141 transmits more light than it reflects. For example, the light splitting section 1141 may transmit 70% of the incoming light and reflect the remaining 30% of the incoming light. The light splitting section 1141 may be a beam splitter. The light splitting section 1141 is configured to transmit light in the longitudinal direction of the endoscope 1101. Also, the light splitting section 1141 is configured to reflect light in the direction substantially orthogonal to the longitudinal direction of the endoscope 1101.

The imaging lens 1151 causes the light reflected by the light splitting section 1141 to be imaged on the first imaging element 1142. The first imaging element 1142 receives the light reflected by the light splitting section 1141. The imaging lens 1152 causes the light transmitted by the light splitting section 1141 to be imaged on the second imaging element 1143. The zoom lens system 1153 expands the light that has passed through the imaging lens 1152, after which the expanded light enters the second imaging element 1143. The second imaging element 1143 receives the light that has passed through the zoom lens system 1153. The zoom lens system 1153 may be initially positioned so as to be capable of enlarging the image of the object created by the light transmitted by the light splitting section 1141. In other words, the zoom lens system 1153 may be initially positioned so as to enable the second imaging element 1143 to capture a larger image than the image captured by the first imaging element 1142. In this case, the second imaging element 1143 receives part of the light transmitted by the light splitting section 1141. The image created by the light received by the second imaging element 1143 is part of the image created by the light received by the first imaging element 1142.

As described above, the light splitting section 1141 and the zoom lens system 1153 are arranged along the longitudinal direction of the insertion portion of the endoscope 1101. Therefore, the endoscope system 1100 can capture both normal images and enlarged images without increasing the diameter of the end portion 1121 of the endoscope 1101. Note that the normal image is a non-zoomed image, specifically speaking, the image captured by the first imaging element 1142. On the other hand, the enlarged image is a zoomed image, specifically speaking, the image zoomed by the zoom lens system 1153 and captured by the second imaging element 1143. Accordingly, when the second imaging element 1143 captures an image without the zooming by the zoom lens system 1153, the captured image is not an enlarged image but a normal image. In addition, when the second imaging element 1143 captures an image without the zooming by the zoom lens system 1153, the angle of view of the captured image is substantially equal to the angle of view of the image captured by the first imaging element 1142. That is to say, the image captured by the first imaging element 1142 is a normal image. The enlarged image is obtained by enlarging the normal image.

When splitting the incoming light, the light splitting section 1141 transmits more light than it reflects. With such a configuration, the enlarged image captured by the second imaging element 1143 can be bright. Generally speaking, when desiring to observe closely a suspicious diseased site, a user captures an enlarged image of the suspicious diseased site and examines the captured image. The present embodiment can advantageously display bright enlarged images. The user desires normal images when s/he wants to know whether there is any possible diseased site or where a diseased site might be, dark normal images will not cause much problem. The light splitting section 1141 may be alternatively configured to transmit and reflect the same amount of light. For example, the light splitting section 1141 may be formed by a semitransparent mirror.

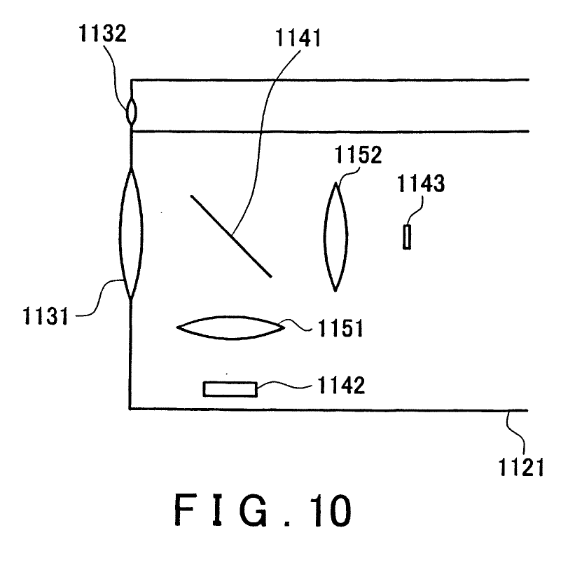

FIG. 10 illustrates another example of the image capturing section 1112 provided within the end portion 1121 of the endoscope 1101. In addition to the guiding section 1131, the light splitting section 1141, the first imaging element 1142, and the second imaging element 1143, the image capturing section 1112 includes an imaging lens 1151 and an imaging lens 1152. The guiding section 1131 guides the light from the object into the endoscope 1101 substantially in the longitudinal direction of the endoscope 1101. When the guiding section 1131 is formed by a lens, the optical axis of the lens is substantially parallel to the longitudinal direction of the endoscope 1101. The light splitting section 1141 splits, into two sets of light rays, the light guided into the endoscope 1101 by the guiding section 1131, by transmitting part of the light and reflecting the rest. The light splitting section 1141 transmits more light than it reflects. The light splitting section 1141 may be a beam splitter. The light splitting section 1141 may be configured to transmit light in the longitudinal direction of the endoscope 1101. Also, the light splitting section 1141 may be configured to reflect light in the direction substantially orthogonal to the longitudinal direction of the endoscope 1101.

The imaging lens 1151 causes the light reflected by the light splitting section 1141 to be imaged on the first imaging element 1142. The first imaging element 1142 receives the light reflected by the light splitting section 1141. The first imaging element 1142 receives one of the sets of light rays, produced by the light splitting section 1141, that has a small amount of light. The imaging lens 1152 causes the light transmitted by the light splitting section 1141 to be imaged on the second imaging element 1143. The second imaging element 1143 receives the light transmitted by the light splitting section 1141. The second imaging element 1143 receives one of the sets of light rays, produced by the light splitting section 1141, that has a larger amount of light. The second imaging element 1143 is smaller in size than the first imaging element 1142. The second imaging element 1143 has a smaller area of effective pixels than the first imaging element 1142, and has a higher resolution per unit area than the first imaging element 1142. The image created by the light received by the second imaging element 1143 corresponds to part of the image created by the light received by the first imaging element 1142. In other words, the light received by the second imaging element 1143 may be part of the light received by the first imaging element 1142. The image created by the light received by the second imaging element 1143 may correspond to the central portion of the image created by the light received by the first imaging element 1142. Here, the area of effective pixels refers to the area of the region having pixels that actually receive light from the object.

With the above-described configuration, the second imaging element 1143 can capture an enlarged image obtained by enlarging part of the image captured by the first imaging element 1142. The second imaging element 1143 may be shifted. In this manner, the second imaging element 1143 can capture images of different regions. Here, the second imaging element 1143 is shifted in the direction vertical to the optical axis of the light received by the second imaging element 1143. The image capturing section 1112 may include a shift driving section that shifts the second imaging element 1143. As discussed above, there are provided the first imaging element 1142 and the second imaging element 1143 that has a smaller area of effective pixels and a higher resolution per unit area than the first imaging element 1142 in the end portion of the endoscope 1101. Therefore, the present embodiment can capture normal images and enlarged images without increasing the diameter of the end portion 1121 of the endoscope 1101. Furthermore, when splitting the incoming light, the light splitting section 1141 transmits more light than it reflects. Consequently, the second imaging element 1143 can capture bright enlarged images. Note that the light splitting section 1141 may alternatively be configured to transmit and reflect the same amount of light.

The following describes how the endoscope system 1100 operates. When the emitting section 1106 emits light, the return light from the object under observation is guided into the endoscope 1101 by the guiding section 1131. The light splitting section 1141 splits the incoming light into two sets of light rays. Specifically speaking, the light splitting section 1141 reflects part of the incoming light in the direction substantially orthogonal to the longitudinal direction of the endoscope 1101, and transmits a larger amount of light in the longitudinal direction of the endoscope 1101. The imaging lens 1151 causes the light reflected by the light splitting section 1141 to be imaged on the first imaging element 1142. The first imaging element 1142 receives the light that has passed through the imaging lens 1151. The imaging lens 1152 causes the light transmitted by the light splitting section 1141 to be imaged on the second imaging element 1143. When the image capturing section 1112 has the configuration shown in FIG. 9 and the zoom lens system 1153 is positioned so as to be capable of expanding the light from the object, the second imaging element 1143 receives part of the light that has passed through the imaging lens 1152. When the image capturing section 1112 has the configuration shown in FIG. 10, the second imaging element 1143 receives part of the light that has passed through the imaging lens 1152.

The first image generating section 1102 generates the first image from the image captured by the first imaging element 1142 and outputs the first image to the display control section 1104. The second image generating section 1103 generates the second image from the image captured by the second imaging element 1143 and outputs the second image to the display control section 1104. The display control section 1104 causes the display section 1105 to display the first image. The display control section 1104 causes the display section 1105 to display the second image. The display control section 1104 also causes the display section 1105 to display the image obtained by combining together the first and second images.

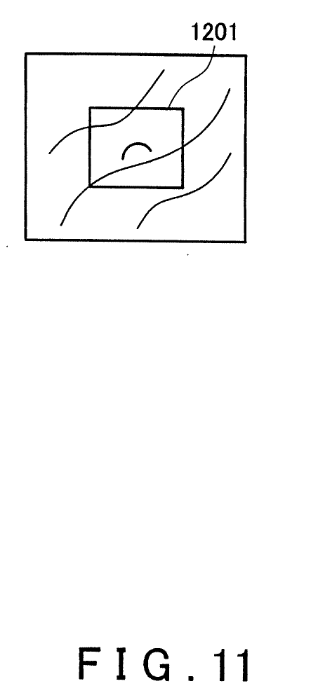

FIG. 11 illustrates an example of the first image displayed. The display control section 1104 may cause the display section 1105 to display the first image when the normal observation mode is selected. The display control section 1104 may cause the display section 1105 to display, on the first image, a frame 1201 indicating the boundary of the second image. In other words, the frame 1201 indicates the region whose image is captured by the second imaging element 1143. In this manner, the user can easily know which region will be enlarged. By viewing the first image displayed on the display section 1105, the user can locate a diseased site. The user moves the end portion of the endoscope 1101 so that a suspicious diseased site is placed within the frame 1201.

When the image capturing section 1112 has the configuration shown in FIG. 9, driving the zoom lens system 1153 by the user's zoom manipulation during the normal observation mode may change the size of the frame 1201 displayed. In other words, as the zoom lens system 1153 moves, the frame 1201 may indicate the region light from which is currently received by the second imaging element 1143. When the image capturing section 1112 has the configuration shown in FIG. 9, the display control section 1104 may cause the display section 1105 to display the image resulting from combining together the first and second images if the zoom lens system 1153 is positioned so as not to enlarge the image of the object during the normal observation mode. Specifically speaking, the display control section 1104 may cause the display section 1105 to display an image obtained by adding together the first and second images. In other words, the display control section 1104 may cause the display section 1105 to display a combination of the first and second images when the zoom lens system 1153 is positioned such that the images captured by the first and second imaging elements 1142 and 1143 have the same angle of view. In this manner, the endoscope system 1100 can display bright normal images. In this case, since the first and second imaging elements 1142 and 1143 image-capture the same region, the frame 1201 may not be displayed on the normal image.

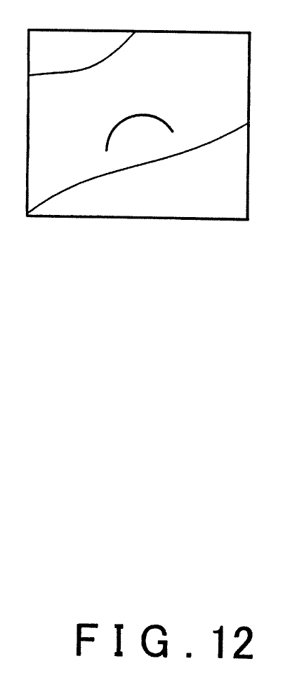

FIG. 12 illustrates an example of the second image displayed. The display control section 1104 may cause the display section 1105 to display the second image when the enlarged observation mode is selected. The second image is the enlarged version of the image within the frame 1201 shown in FIG. 11. Accordingly, while the first image is being displayed, the user may move the frame 1201 to put a suspicious diseased site within the frame 1201 and selects the enlarged observation mode. In this manner, enlarged display of the image within the frame 1201 is achieved. When the image capturing section 1112 has the configuration shown in FIG. 9, the zoom lens system 1153 may be further moved in the zoom direction while the second image is being displayed. In this manner, the endoscope system 1100 can display a further enlarged image.

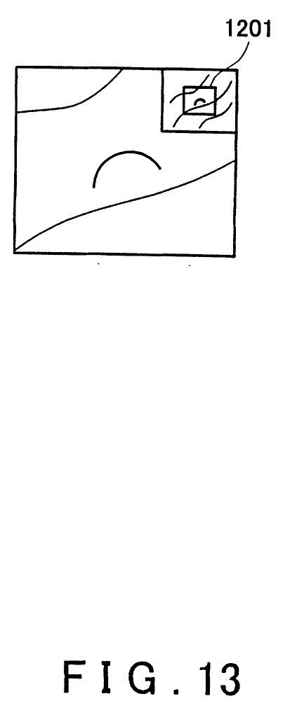

FIG. 13 illustrates an exemplary concurrent display of the first and second images. The display control section 1104 may cause the display section 1105 to concurrently display the first and second images when the enlarged observation mode is selected. Here, the display control section 1104 causes the display section 1105 to display the first image in a reduced size on the second image being displayed. In this case, the frame 1201 indicating the boundary of the second image may be displayed on the first image. In this manner, the user can easily know which portion is currently being displayed in the enlarged state.

When the image capturing section 1112 has the configuration shown in FIG. 9, the zoom lens system 1153 is positioned so as not to enlarge the image of the object during the normal observation mode and the display section 1105 is controlled to display the image obtained by adding together the first and second images. When the user performs zoom manipulation, the endoscope system 1100 may switch the operational mode from the normal observation mode to the enlarged observation mode and display the second image. Here, as shown in FIG. 13, the first image may be displayed in a reduced size on the second image. In this case, the frame 1201 may be also displayed to indicate the region whose image is captured by the second imaging element 1143.

The above-described embodiment may be modified as follows.
(1) When the image capturing section 1112 has the configuration shown in FIG. 10, the first imaging element 1142 may alternatively receive the light transmitted by the light splitting section 1141 and the second imaging element 1143 may alternatively receive the light reflected by the light splitting section 1141. If such is the case, the light splitting section 1141 reflects a larger amount of light than it transmits. In other words, the light splitting section 1141 splits the incoming light such that the second imaging element 1143 receives more light than the first imaging element 1142.
(2) When the image capturing section 1112 has the configuration shown in FIG. 10, the area of effective pixels may not necessarily be smaller in the second imaging element 1143 than in the first imaging element 1142. For example, the first and second imaging elements 1142 and 1143 may have the same area of effective pixels. If such is the case, however, the second imaging element 1143 still has a higher resolution per unit area than the first imaging element 1142. With this alternative configuration, the second imaging element 1143 can also produce enlarged images.
(3) The display control section 1104 may cause the display section 1105 to simultaneously display the first and second images. For example, the display control section 1104 may cause the display section 1105 to simultaneously display the first image in a first display region and the second image in a second display region. In this case, the frame 1201 may be displayed on the first image.
(4) When the image capturing section 1112 has the configuration shown in FIG. 10, the sensitivity may be set higher for the first imaging element 1142 than for the second imaging element 1143. The sensitivity itself of the first imaging element 1142 may be set higher than that of the second imaging element 1143. Alternatively, the sensitivity of the first imaging element 1142 may be raised by, when reading the accumulated charges of the respective pixels of the first imaging element 1142, adding together the accumulated charges of a plurality of pixels. In this way, the endoscope system 1100 can produce bright normal images.
(5) To cause the display section 1105 to display the normal image, the display control section 1104 may cause the display section 1105 to display the first image excluding the image of the region whose image is captured by the second imaging element 1143 and display the second image in the region whose image is captured by the second imaging element 1143. In other words, as shown in FIG. 11, the display control section 1104 may cause the display section 1105 to display the first image excluding the image of the region within the frame 1201 and display the second image in the region within the frame 1201. Alternatively, the display control section 1104 may cause the display section 1105 to display the first image excluding the image of the region whose image is captured by the second imaging element 1143 and display an image obtained by adding together (i) the second image and (i) a partial image of the first image within the region whose image is captured by the second imaging element 1143, in the region whose image is captured by the second imaging element 1143. In other words, as shown in. FIG. 11, the display control section 1104 may cause the display section 1105 to display the first image excluding the image of the region within the frame 1201 and display the image obtained by adding together the second image and the partial image of the first image within the frame 1201, in the frame 1201. In this case, the frame 1201 may be also displayed. Here, the second image may be displayed in a lower resolution or without lowering the resolution. In this manner, the image within the frame 1201 can be displayed with higher brightness than the image outside the frame 1201. This enables the user to closely examine the object within the frame 1201 even when the endoscope system 1100 displays normal images.
(6) In order that the second imaging element 1143 can capture brighter images, the emitting section 1106 may control the intensity of the emitted light such that the light entering the second imaging element 1143 has a higher intensity than the light not entering the second imaging element 1143. In this manner, the second imaging element 1143 can capture bright images. When this configuration is employed, the light splitting section 1141 maybe formed by a semitransparent mirror. Since the light received by the second imaging element 1143 is part of the light received by the first imaging element 1142, brightness is higher in the region, of the image captured by the first imaging element 1142, that is imaged by the second imaging element 1143 than in the remaining region. This is explained with reference to FIG. 11, for example. The image within the frame 1201 is brighter than the image outside the frame 1201 in the first image. This enables the user to closely examine the condition of the object within the frame 1201 while the first image is being displayed.
(7) The above-described modification examples (1) to (6) may be freely combined with each other as far as no contradictions take place.

Although some aspects of the present invention have been described by way of exemplary embodiments, it should be understood that those skilled in the art might make many changes and substitutions without departing from the spirit and the scope of the present invention which is defined only by the appended claims.

The claims, specification and drawings describe the processes of an apparatus, a system, a program and a method by using the terms such as operations, procedures, steps and stages. When a reference is made to the execution order of the processes, wording such as “before” or “prior to” is not explicitly used. The processes may be performed in any order unless an output of a particular process is used by the following process. In the claims, specification and drawings, a flow of operations may be explained by using the terms such as “first” and “next” for the sake of convenience. This, however, does not necessarily indicate that the operations should be performed in the explained order.

What is claimed is:

1. An image capturing apparatus comprising:
a light splitting section that splits light from an object into first light and second light in such a manner that (i) a split ratio of light in a central region of an image of the object is different from a split ratio of light in a peripheral region of the image and (ii) the second light has a smaller amount of light in the central region than the first light;
a first imaging element that receives the first light;
a second imaging element that receives the second light; and
a zoom lens system that is provided between the light splitting section and the first imaging element.

2. The image capturing apparatus as set forth in claim 1, wherein
the light splitting section splits the light from the object into the first light and the second light such that the second light has a smaller amount of light in the central region than the first light and has a larger amount of light in the peripheral region than the first light.

3. The image capturing apparatus as set forth in claim 1, wherein
the light splitting section includes
a reflective mirror that has an opening positioned in correspondence with the central region.

4. The image capturing apparatus as set forth in claim 1, wherein
the light splitting section includes:
abeam splitter that is positioned in correspondence with the central region; and
a reflective mirror that is positioned in the same plane as the beam splitter in correspondence with the peripheral region.

5. The image capturing apparatus as set forth in claim 3, further comprising:
a first light path adjusting section that causes the image of the object to be formed on the reflective mirror;
a second light path adjusting section that is provided between the light splitting section and the first imaging element, the second light path adjusting section causing the first light to be imaged on the first imaging element; and
a third light path adjusting section that is provided between the light splitting section and the second imaging element, the third light path adjusting section causing the second light to be imaged on the second imaging element.

6. The image capturing apparatus as set forth in claim 1, further comprising
an image generating section that generates an image of the central region from the first light received by the first imaging element and generates an image of the peripheral region from the second light received by the second imaging element.

7. The image capturing apparatus as set forth in claim 6, further comprising:
an image display control section that combines together (i) the image of the central region generated from the first light received by the first imaging element and (ii) the image of the peripheral region generated from the second light received by the second imaging element to create a combined image and displays the combined image.

8. The image capturing apparatus as set forth in claim 7, wherein
the image display control section overlays (i) a complete image resulting from combining together the image of the central region and the image of the peripheral region on (ii) the image of the central region that has been enlarged by the zoom lens system, and displays the resulting image.

9. The image capturing apparatus as set forth in claim 1, wherein
the image capturing apparatus is an endoscope apparatus including an endoscope, and
the light splitting section, the first imaging element, the second imaging element, and the zoom lens system are provided in an end of an insertion portion of the endoscope.

10. The image capturing apparatus as set forth in claim 9, wherein
the light splitting section supplies the first light in a longitudinal direction of the endoscope and supplies the second light in a direction substantially orthogonal to the longitudinal direction of the endoscope.

11. An endoscope including an insertion portion, wherein
the insertion portion comprises, at an end thereof;
a guiding section that guides light from an object into the endoscope;
a light splitting section that reflects the guided light in a direction substantially orthogonal to a longitudinal direction of the endoscope and transmits the guided light in the longitudinal direction of the endoscope, the light splitting section transmitting a larger amount of the guided light than reflecting;
a first imaging element that receives the light reflected by the light splitting section;
a second imaging element that receives the light transmitted by the light splitting section; and
a zoom lens system that is provided between the light splitting section and the second imaging element.

12. The endoscope as set forth in claim 11, wherein
an image created by light received by the second imaging element corresponds to part of an image created by light received by the first imaging element.

13. An endoscope including an insertion portion, wherein
the insertion portion comprises, at an end thereof;
a guiding section that guides light from an object into the endoscope;
a light splitting section that splits the guided light into two sets of light rays;
a first imaging element that receives one of the two sets of light rays produced by the light splitting section; and
a second imaging element that receives the other of the two sets of light rays produced by the light splitting section, wherein
the second imaging element has a smaller area of effective pixels and a higher resolution per unit area than the first imaging element.

14. The endoscope as set forth in claim 13, wherein
the light splitting section splits the guided light into the two sets of light rays having different amounts of light,
the first imaging element receives one of the two sets of light rays that has a smaller amount of light, and
the second imaging element receives one of the two sets of light rays that has a larger amount of light.

15. The endoscope as set forth in claim 13, wherein
an image created by light received by the second imaging element corresponds to part of an image created by light received by the first imaging element.
